(19) United States
(12) Patent Application Publication
(10) Pub. No.: US 2017/0052782 A1
(43) Pub. Date: Feb. 23, 2017

(54) DELAYED ZERO-OVERHEAD LOOP INSTRUCTION

(71) Applicant: Apple Inc., Cupertino, CA (US)

(72) Inventors: Binu K. Mathew, Los Gatos, CA (US); Julia C. Erhard, San Jose, CA (US); Joseph J. Cheng, Palo Alto, CA (US)

(21) Appl. No.: 14/831,955

(22) Filed: Aug. 21, 2015

(51) Int. Cl. G06F 9/30

(52) U.S. Cl. CPC G06F 9/3005; G06F 9/30101

(57) ABSTRACT

An apparatus may include a counter circuit and an execution unit. The execution unit may be configured to receive and execute a first instruction. The first instruction may include a first number corresponding to a first number of instructions of a plurality of instructions, a second number corresponding to a number of times to execute a subset of the plurality of instructions, and a third number corresponding to a number of instructions in the subset. The execution unit may be further configured to initialize a first count value in the counter circuit to the second number in response to the execution of the first instruction, to execute the first number of the plurality of instructions, and to execute the subset of the plurality of instructions. The counter circuit may be configured to modify the first count value in response to determining a last instruction of the subset has been retired.

### BACKGROUND

Technical Field

Embodiments described herein are related to the field of integrated circuit implementation, and more particularly to the implementation of processor instruction sets.

Description of the Related Art

Computing systems may include one or more processors for executing software programs. Each processor may be configured to execute instructions belonging to a given instruction set architecture (ISA). Processors read or “fetch” instructions belonging to a program which is stored in a memory. Program instructions may be fetched by the processor directly from some memories, such as Read-Only Memories (ROMs) and NOR-gate flash, or, in other embodiments, may be copied from a hard-disk drive (HDD), solid-state drive (SSD), or server into a local volatile memory before being fetched. Once an instruction has been fetched, the processor may execute it.

Processors may be considered “general purpose” if they are capable of executing programs for a wide variety of applications, such as processors used in desktop and notebook computers. In contrast, “application specific” processors (e.g. ASICs) are capable of executing programs for a limited number of, or even a single, application, such as some research equipment or other low volume applications. Digital signal processors (DSPs) are a form of processor that may be considered somewhere between general purpose and application specific processors. DSPs typically provide more capabilities for performing rapid processing and analysis of input data than a comparable general purpose processor yet support a wider variety of applications than an ASIC. DSPs may support an instruction set architecture that includes commands for fast and efficient processing of data, thereby permitting quick analysis of data for generating deterministic outputs.

### SUMMARY OF THE EMBODIMENTS

Various embodiments of a processor are disclosed. Broadly speaking, a system, an apparatus, and a method are contemplated in which the apparatus includes a first counter circuit and an execution unit. The execution unit may be configured to receive and execute a first program instruction of a plurality of program instructions, wherein the first program instruction may include a first number corresponding to a number of program instructions in a first subset of the plurality of program instructions, a second number corresponding to a number of times to execute a second subset of the plurality of program instructions, and a third number corresponding to a number of program instructions in the second subset. The execution unit may be further configured to initialize a first count value in the first counter circuit to the second number in response to the execution of the first program instruction. The execution unit may also be configured to execute the first subset of the plurality of program instructions, and to execute the second subset of the plurality of program instructions. The first counter circuit may be configured to modify the first count value in response to a determination that a last program instruction of the second subset has been retired.

In a further embodiment, the execution unit may be further configured to repeat execution of the second subset of the plurality of program instructions in response to a determination that the first count value is greater than a predetermined value. In another embodiment, the execution unit may be further configured to execute a program instruction excluded from the first subset and the second subset of the plurality of program instructions in response to a determination that the first count value is equal to a predetermined value.

In one embodiment, the apparatus may include a second counter circuit. The execution unit may be further configured to initialize a second count value in the second counter circuit to the first number in response to the execution of the first program instruction. The second counter circuit may be configured to modify the second count value in response to a determination that a program instruction in the first subset has been executed. In a further embodiment, the execution unit may be further configured to execute a first program instruction of the second subset of the plurality of program instructions in response to a determination that the second count value equals a predetermined value.

In an embodiment, the execution unit may be further configured to add, in response to the execution of the first program instruction, the first number to a first value of a program counter to generate a fourth number, and store the fourth number in a compare register. In a further embodiment, the execution unit may be further configured to execute a first program instruction of the second subset of the plurality of program instructions in response to a determination that a second value of the program counter equals the fourth value.

### BRIEF DESCRIPTION OF THE DRAWINGS

The following detailed description makes reference to the accompanying drawings, which are now briefly described.

FIG. 1 illustrates a block diagram of an embodiment of a computing system.

FIG. 2 illustrates a block diagram of a processor.

FIG. 3 shows a diagram of tables representing commands stored in a memory and a progression of the execution of the commands by a processor.

FIG. 4 illustrates a flow diagram illustrating an embodiment of a method for implementing a delayed zero-overhead loop instruction.

FIG. 5 shows a block diagram of a program compiler.

FIG. 6 shows a system utilizing an embodiment of a processor disclosed herein.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph (f) interpretation for that unit/circuit/component. More generally, the recitation of any element is expressly intended not to invoke 35 U.S.C. §112, paragraph (f) interpretation for that element unless the language “means for” or “step for” is specifically recited.

### DETAILED DESCRIPTION OF EMBODIMENTS

Some processors or processor cores, such as, for example, some Digital Signal Processors (DSPs), include an instruction for determining a program loop. A program loop is a series of instructions that may be executed a plurality of times. Some instruction set architectures for processors may include an instruction for setting up a program loop that executes a first number of subsequent instructions that are executed a second number of times as indicated by a respective first and second operand of the instruction. A program loop determined by such an instruction may be referred to as a “zero overhead loop” if zero processor cycles are required between each iteration of the loop. In other words, a zero overhead loop expends no additional cycles between execution of the last instruction of the loop and a next execution of the first instruction of the loop. In a non-zero overhead loop, overhead may include, for example, determining when exit the program loop, branching to the start of the loop, and incrementing/decrementing loop count values.

Typical zero overhead loop instructions may include the subsequent instruction as part of the program loop. In some software programs, it may be beneficial to execute a zero overhead loop command and then execute one or more instructions before beginning the actual program loop. The embodiments illustrated in the drawings and described below may provide a method for implementing a delayed zero overhead loop instruction, in which one or more instructions subsequent to the delayed zero overhead loop instruction may be excluded from the program loop. The delayed zero overhead loop instruction may include operands for determining a number of instructions to include in the program loop, a number of times to execute the program loop, and a number of subsequent instructions to execute before beginning the program loop.

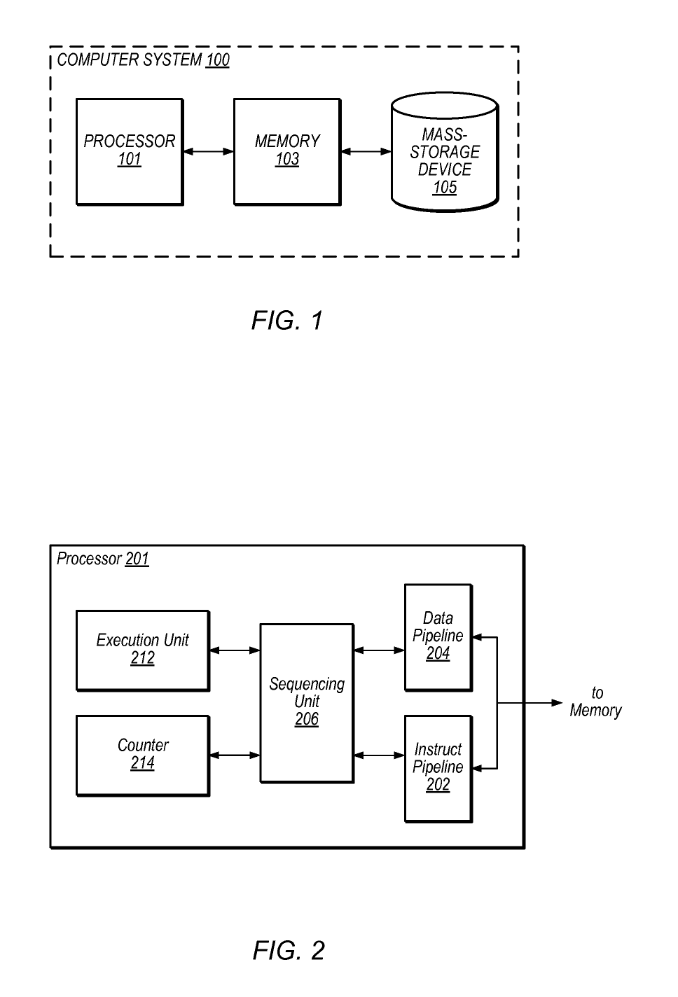

A block diagram of an embodiment of computing system is illustrated in FIG. 1. Computer system 100 includes a processor 101, a memory 103, and a mass-storage device 105. It is noted that although specific components are shown and described in computer system 100, in alternative embodiments different components and numbers of components may be present in computer system 100. For example, computer system 100 may not include some of the memory hierarchy (e.g., memory 103 and/or mass-storage device 105). In addition, computer system 100 may include graphics processors, video cards, video-capture devices, user-interface devices, network cards, optical drives, and/or other peripheral devices that are coupled to processor 101 using a bus, a network, or another suitable communication channel (all not shown for simplicity).

In various embodiments, processor 101 may be representative of a general-purpose processor that performs computational operations. For example, processor 101 may be a central processing unit (CPU) such as a microprocessor, a microcontroller, a digital signal processor, an application-specific integrated circuit (ASIC), or a field-programmable gate array (FPGA). Although one processor 101 is illustrated, some embodiments of system 100 may include more than one processor 101. Further, in some embodiments, processor 101 may correspond to a processing core complex including one or more processors or processing cores. In various embodiments, processor 101 may implement any suitable instruction set architecture (ISA), such as, e.g., ARM™, C6000™, Blackfin° or x86 ISAs, or combination thereof.

The memory 103 and mass-storage device 105 are storage devices that collectively form a memory hierarchy that stores data and instructions for processor 101. More particularly, the mass-storage device 105 may be a high-capacity, non-volatile memory, such as a disk drive or a large flash memory unit with a long access time, while memory 103 may be smaller, with shorter access times. Memory 103 may store copies of frequently used data. Memory 103 may be representative of a memory device in the dynamic random access memory (DRAM) family of memory devices. In some embodiments, memory 103 and mass-storage device 105 are shared between one or more processors in computer system 100.

It is noted the data structures and program instructions (i.e., code) described below may be stored on a non-transitory computer-readable storage device, which may be any device or storage medium that can store code and/or data for use by a computer system (e.g., computer system 100). Generally speaking, a non-transitory computer-readable storage device includes, but is not limited to, volatile memory, non-volatile memory, magnetic and optical storage devices such as disk drives, magnetic tape, compact discs (CDs), digital versatile discs or digital video discs (DVDs), or other media capable of storing computer-readable media now known or later developed. As such, mass-storage device 105 and memory 103 are examples of non-transitory computer readable storage devices.

It is also noted that the system illustrated in FIG. 1 is merely an example. In other embodiments, different functional blocks and different configurations of functions blocks may be possible dependent upon the specific application for which the system is intended.

Turning to FIG. 2, a block diagram illustrating an embodiment of a processor, such as, for example, processor 101 of FIG. 1 is shown. In the embodiment shown in FIG. 2, processor 201 may include a number of pipeline stages, although for brevity not all are shown in FIG. 2. Accordingly, as shown, processor 201 includes instruction pipeline 202 and data pipeline 204 coupled to sequencing unit 206. Sequencing unit 206 is further coupled to execution unit 212 and counter circuit 214.

In various embodiments, processor 201 may perform computational operations such as, for example, logical operations, mathematical operations, or bitwise operations for an associated type of operand. Each operation is received as one of a predetermined number of instructions from an instruction set architecture (ISA) supported by processor 201. Processor 201 receives instructions and corresponding data via instruction pipeline 202 and data pipeline 204, respectively. The memory sizes of instruction pipeline 202 and data pipeline 204 may or may not be equal and each may be of any suitable size for storing one or more instructions and data to be executed. In some embodiments, instruction pipeline 202 and data pipeline 204 may be implemented in a single pipeline memory containing both instructions and data.

Sequencing unit 206, in the present embodiment, controls a flow of instructions and data into instruction pipeline 202 and data pipeline 204, respectively. Sequencing unit 206 retrieves a next instruction to be executed from instruction pipeline 202 and retrieves the corresponding data from data pipeline 204 as previous instructions are retired. As used herein, a “retired” instruction refers to an instruction that has completed successfully. Sequencing unit 206 includes a register that stores an address for a next instruction fetch, referred to herein as a “program counter or PC”. The PC may also be referred to as an instruction pointer, an instruction address register, or an instruction counter. When sequencing unit 206 request an instruction and associated data from memory, the PC is incremented by a number corresponding to the number of memory locations occupied by the instruction and data, such that the PC will point to the address of the next instruction in the memory. In cases where program flow deviates from linear execution, such as, for example, to branch to the beginning of a program loop or a subroutine, the PC will be loaded with the corresponding address rather than incremented.

Upon retrieving a next instruction from instruction pipeline 202, sequencing unit 206 directs the instruction to execution unit 212 or processes the instruction itself, as determined by the type of instruction retrieved. Logical, mathematical, and bitwise instructions may be directed to execution unit 212. Program flow instructions, for example, instructions that enable branches or loops, are processed by sequencing unit 206. Branching and looping instructions may cause the program flow to deviate from a sequential, linear order of instruction execution. Since sequencing unit 206 controls program flow, such instructions are processed within sequencing unit 206 allowing the PC to be updated if a program branch or loop is taken.

Execution unit 212, in the present embodiment, processes instructions in the supported ISA. In some embodiments, execution unit 212 may include multiple execution engines or coprocessors for processing various portions of the instruction set. For example, execution unit 212 may include any combination of a multiply and accumulate block (MAC), a floating point unit (FPU), an arithmetic logic unit (ALU), load store unit (LSU), or other types of execution engines. Execution unit 212 includes one or more registers for storing operands of the operations and for storing a result.

Counter circuit 214 includes one or more registers for storing count values. In some embodiments, counter circuit 214 counts down to zero (or other predetermined value) from the count value, while in other embodiments, counter circuit 214 counts from zero (or other predetermined starting value) up to the stored count value. Counter circuit 214 may decrement (or increment) the stored count value in response to an instruction retiring. In the present embodiment, sequencing unit 206 uses counter circuit 214 to determine when a number of instructions have executed by storing the number in a count value register. Counter circuit 214 decrements the count value for each retired instruction. When the count value reaches zero, counter circuit 214 asserts a signal to indicate the number of instructions have been retired. As stated, counter circuit 214 may include more than one count value register, allowing for different count values to be managed in parallel. In some embodiments, each count value register may be enabled and disabled individually, allowing a count value to be pre-loaded, but not modified until sequencing unit 206 enables that register.

For example, sequencing unit 206 retrieves a loop instruction from instruction pipeline 202 to initialize a program loop. The loop instruction includes three operands, a first operand indicating a number of instructions to execute before starting the program loop (referred to herein as a “delay count”), a second operand indicating a number of times to execute the program loop (referred to herein as a “loop count”), and a third operand indicating a number of instructions to include in the program loop (referred to herein as a “loop size”). Sequencing unit 206 stores each of the three operands in respective first, second and third count value registers. The second and third count value registers are disabled, such that only the first count value register will decrement on an instruction retirement. Program execution continues in a linear flow until the first count value register reaches zero, at which point the second and third count value registers are enabled. The third count value register (corresponding to the loop size), upon being enabled, decrements on each instruction retirement. The second count value register (corresponding to the loop count) decrements when the third count value register reaches zero, rather than decrementing on each instruction retirement. Program execution continues in a linear flow until the third count value register reaches zero. Sequencing unit 206 receives an indication from counter 214 that the third count value register has reached zero, but does not receive a similar indication for the second count value register. Sequencing unit 206, therefore, adjust the PC to point back to the first instruction of the program loop and re-initializes the third count value register with the loop size. The process repeats until the second count value register reaches zero. Sequencing unit 206, in response to an indication from counter circuit 214 that the second count value register has reached zero, increments the PC to point a next instruction after the program loop and program execution continues in a linear flow until another branch or loop instruction is retrieved.

It is noted that the embodiment of processor 201 as illustrated in FIG. 2 is merely an example. The illustration of FIG. 2 has been simplified to highlight features relevant to this disclosure. Various embodiments may include different configurations of the functional blocks, including additional blocks.

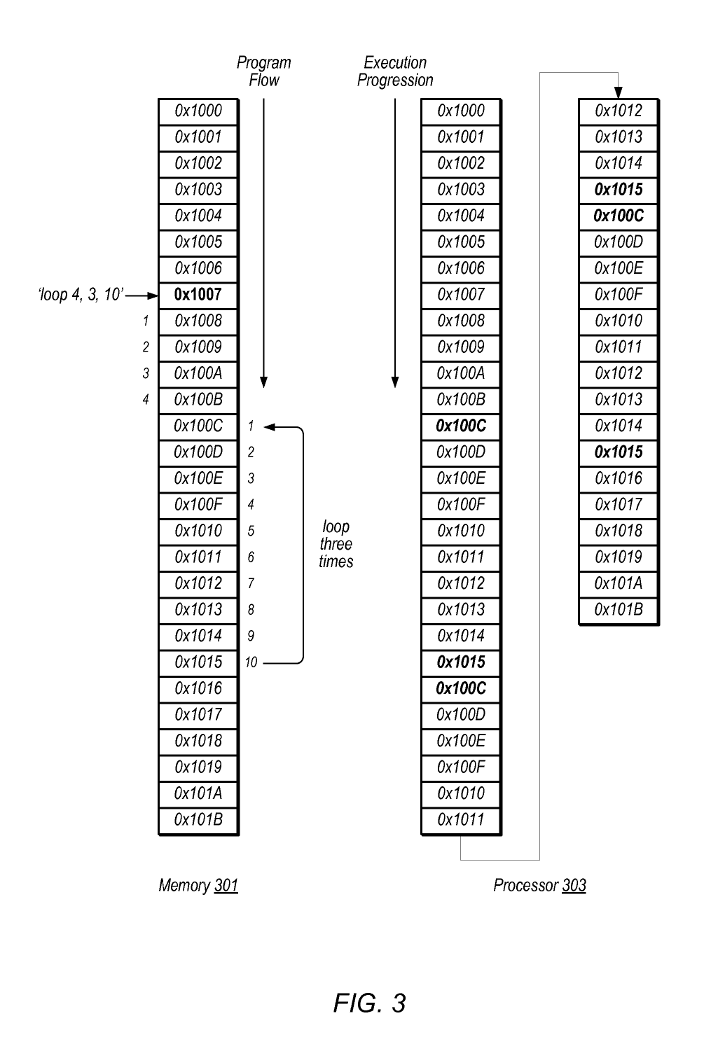

Moving to FIG. 3, a diagram of tables representing commands stored in a memory and a progression of the execution of the commands by a processor is presented. FIG. 3 includes memory table 301, which illustrates program instructions stored in a memory, and processor table 303, which shows an order of execution by a processor of the program instructions in the memory, including a delayed zero-overhead loop instruction. Memory table 301 may correspond to any suitable storage medium, including, for example, memory 103 or mass storage device 105 in FIG. 1. Processor table 303 may correspond to any suitable processor, such as, for example, processor 101 in FIG. 1.

In the illustrated embodiment, memory table 301 corresponds to a series of program instructions stored in memory 103, with each box representing one instruction. The number in each box represents a memory address (in hexadecimal format) for the instruction. It is noted that, for the sake of simplicity, the current embodiment includes one instruction per memory location, including associated operands. It is contemplated, however, that in other embodiments, one instruction may span two or more memory locations, including associated operands. It is also noted that while only 16 bit addresses are shown, other embodiments may include addresses of any suitable length.

At memory address 0x1007, a loop instruction is stored. In the present embodiment, the loop instruction corresponds to a delayed zero-overhead loop instruction. The loop instruction includes three operands corresponding to a first operand corresponding to a delay count indicating four instructions are to be executed before starting the loop, a second operand corresponding to a loop count indicating that the loop is to be executed three times, and a third operand corresponding to a loop size indicating that 10 instructions are to be included in the loop. It is noted that the order of the operands may be different in other embodiments.

Processor table 303 illustrates the order that the instructions of memory table 301 are executed. Beginning at address 0x1000, the instructions are executed in a linear (e.g. sequential) order until the first time the instruction at address 0x1015 is executed and retired. When the loop instruction at address 0x1007 is executed, processor 101 adds the value of the delay count (4) to a current value of the PC (0x1007), thereby generating a value (0x100B) to be used in a first PC match register. Processor 101 stores the generated value of 0x100B into the first PC match register. In addition, processor 101 also adds the value of the loop size (10 or 0xA) to 0x100B, resulting in 0x1015, the address of last instruction of the program loop. The value of 0x1015 is stored in a second PC match register. The value of the loop count (3) is stored in a count value register of a counter circuit in processor 101.

Processor 101 continues to execute the instructions in linear order, eventually reaching the instruction at address 0x100B and triggering the first PC match register, which asserts a signal alerting processor 101 that four instructions have retired. Processor 101 stores a next value of the PC (0x100C) to be used as the starting address of the program loop. Program execution continues in linear order until the value of the PC reaches the value of the second PC match register, 0x1015. Upon the PC reaching the value of second PC match register, the loop count value in the counter circuit is decremented from 3 to 2. Since the loop count value is not zero, processor 101 copies the stored value for the program loop starting address (0x100C) into the PC, causing processor 101 to begin a second execution of the program loop. The process repeats, with the loop count value in the counter circuit being decremented from 2 to 1 after the second execution of the program loop, and then a third time resulting in the loop count value being decremented from 1 to 0. In response to the loop count value reaching zero, processor 101 increments the value of the PC instead of copying the starting address of the program loop, resulting in the instruction at address 0x1016 being executed. Program execution continues in linear order until another loop instruction or a branching instruction is processed.

It is noted that the beginning and end addresses of the program loop as well as the number of loop iterations are determined using a combination of hardware counter circuits and hardware match registers. Since hardware is used, the instructions within the program loop, i.e., the instructions at addresses 0x100C through 0x1015, are not required to be used for setting the start, stop, or iteration limits. The zero-overhead loop instruction does not require that any of the instructions in the loop to be used for managing the loop, hence “zero-overhead” in terms of processor cycles are used during execution of the loop.

It is further noted that the tables in FIG. 3 merely illustrates an example of how instructions may be stored and executed in an embodiment presented in this disclosure. Various other embodiments may include different address sizes, different instruction sizes, and result in a different program progression. It is also noted that a different method for determining the beginning and end of the program loop is presented compared to the description disclosed in FIG. 2.

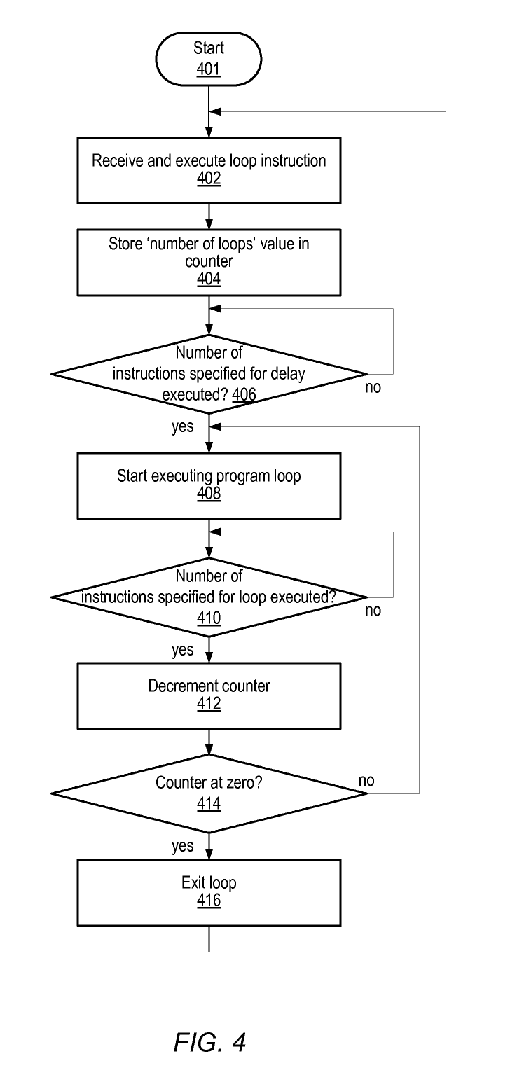

Turning now to FIG. 4, a flow diagram of an embodiment of a method for implementing a delayed zero-overhead loop instruction is illustrated. The method may be applied to a processor, such as, for example, processor 201 in FIG. 2. Referring collectively to FIG. 2 and FIG. 4, the method may begin in block 401.

Processor 201 receives and executes a loop instruction (block 402). In the present embodiment, the loop instruction corresponds to a delayed zero-overhead loop instruction. A first operand associated with the loop instruction corresponds to a number of subsequent instructions to execute before the start of a program loop, i.e., a number of instructions to “delay” the program loop (a “delay count”). A second operand corresponds to a number of times to execute the program loop (a “loop count”). A third operand corresponds to a number of instructions to include in the program loop (a “loop size”).

The value of the loop count is stored in a counter circuit (block 404). Processor 201 stores the loop count value into a first count register in counter circuit 214. In the present embodiment, counter circuit 214 decrements the count registers in response to a counter trigger, and asserts a signal upon a given count register reaching a value of zero. In other embodiments, counter circuit 214 may start a count value at zero, increment the count value in response to the counter trigger, and assert the signal upon the count value reaching a value stored in a given count register. In various embodiments, counter circuit 214 may include a single counter trigger coupled to each count register or each count register may be coupled to a respective counter trigger. The counter trigger may correspond to any suitable signal available in processor 201, such as, for example, a retirement of an instruction, a current value of the PC reaching a predetermined value, or in response to another signal asserted by counter circuit 214.

Further operations of the method may depend upon a number of instructions retired after retiring the loop instruction (block 406). Processor 201 determines if the number of instructions that have been retired is equal to the delay count. To make the determination, processor 201, in some embodiments, stores the delay count into a second count register in counter circuit 214. In such embodiments, counter circuit 214 decrements the second count register in response to each instruction retired, asserting a respective signal when the second count register reaches zero. In other embodiments, to make the determination, processor 201 adds the delay count to a current value of the PC and stores the result into a first PC match register. Each PC match register asserts a signal when a value of the PC matches a value in the respective PC match register. If the number of instructions retired is not equal to the delay count, then the method remains in block 406. When the number of retired instructions matches the delay count, the method moves to block 408 to start the program loop.

Processor 201 begins executing the program loop (block 408). The first instruction of the program loop is identified as the first instruction following the instructions retired during the delay count. On the first iteration of the program loop, processor 201 denotes the address of the first instruction and saves this address in a register (or other suitable type of memory) for future iterations of the loop.

Further operations of the method may depend upon a number of instructions retired since beginning the program loop (block 410). Processor 201 determines if the number of instructions that have been retired since beginning the program loop is equal to the loop size. Processor 201 may make the determination using one of the disclosed techniques as described above for making the determination of the delay count in block 406. Processor 201 may, in some embodiments, store the delay count into a third count register in counter circuit 214, or processor 201 may add the loop size to the value of stored in first PC match register and store the result in a second PC match register. If the number of instructions retired is not equal to the loop size, then the method remains in block 410. When the number of retired instructions matches the loop size, the method moves to block 412 to decrement the first count register.

Upon completing an iteration of the program loop, the first count register is decremented (block 412). Counter circuit 214 decrements the first count register upon a completion of each iteration through the program loop.

Further operations of the method may depend on a value of the first count register (block 414). In response to the first count register reaching a value of zero, counter circuit 214 asserts a respective signal to indicate that program loop has been executed the number of times specified by the loop count. If the respective signal is asserted, then the method moves to block 416 to exit the program loop. Otherwise, processor 201 copies the stored address of the first instruction of the program loop into the PC and moves back to block 408 to repeat the program loop.

Processor 201 exits the program loop (block 416). Once the program loop has been executed the specified number of times, the program exits the program loop by incrementing the PC such that the PC points to the first instruction subsequent to the last instruction of the program loop. In some embodiments, processor 201 may clear or reset any registers for the execution of the program loop. The method returns to block 402 until a next loop instruction is received.

It is noted that the method illustrated in FIG. 4 is merely an example embodiment. Variations on this method are possible. Some operations may be performed in a different sequence, and/or additional operations may be included.

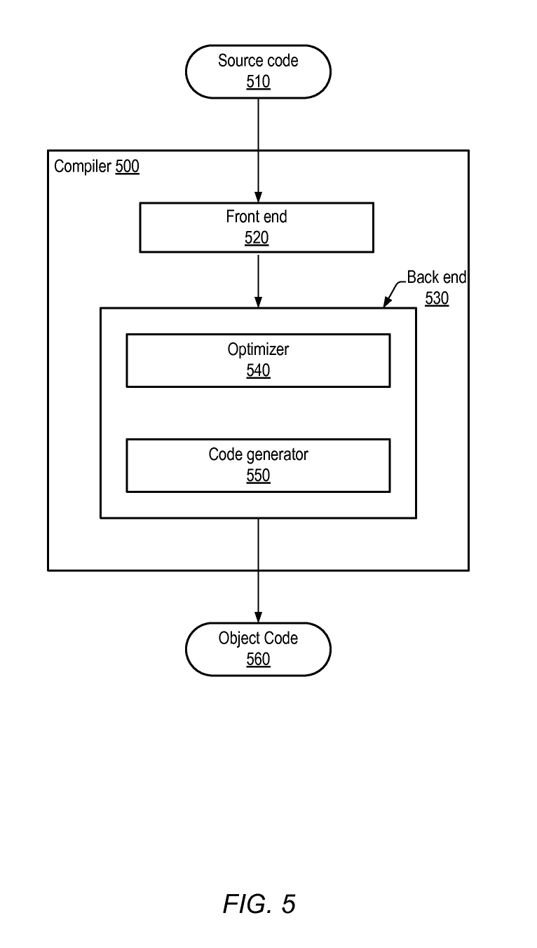

Moving now to FIG. 5, a block diagram of a program compiler is illustrated. FIG. 5 depicts an illustrative compiler that, when executed by computer system 100 of FIG. 1, or another suitable computer system, may be used to generate executable code according to certain embodiments. Compiler 500 includes front end 520 and back end 530, which may in turn include optimizer 540 and code generator 550. As shown, front end 520 receives source code 510, which may correspond to a high-level programming language, and back end 530 produces object code 560, which may correspond to machine instructions defined by an ISA of a target architecture.

While source code 510 is typically written in a high-level programming language, source code 510 may alternatively correspond to a machine-level language such as assembly language. For example, compiler 500 may be configured to apply its optimization techniques to assembly language code in addition to code written in higher-level programming languages. Also, compiler 500 may include a number of different instances of front end 520, each configured to process source code 510 written in a different respective language and to produce a similar intermediate representation for processing by back end 530. In such embodiments, compiler 500 may effectively function as a multi-language compiler.

In an embodiment, front end 520 may be configured to perform preliminary processing of source code 510 to determine whether the source is lexically and/or syntactically correct, and to perform any transformation suitable to ready source code 510 for further processing by back end 530. For example, front end 520 may be configured to process any compiler directives present within source code 510, such as conditional compilation directives that may result in some portions of source code 510 being included in the compilation process while other portions are excluded. Front end 520 may also be variously configured to convert source code 510 into tokens (e.g., according to whitespace and/or other delimiters defined by the source language), determine whether source code 510 includes any characters or tokens that are disallowed for the source language, and determine whether the resulting stream of tokens obeys the rules of syntax that define well-formed expressions in the source language. In different situations, front end 520 may be configured to perform different combinations of these processing activities, may omit certain actions described above, or may include different actions, depending on the implementation of front end 520 and the source language to which front end 520 is targeted. For example, if a source language does not provide a syntax for defining compiler directives, front end 520 may omit a processing action that includes scanning source code 510 for compiler directives.

If front end 520 encounters errors during processing of source code 510, it may abort processing and report the errors (e.g., by writing error information to a log file or to a display). Otherwise, upon sufficiently analyzing the syntactic and semantic content of source code 510, front end 520 may provide an intermediate representation of source code 510 to back end 530. Generally speaking, this intermediate representation may include one or more data structures that represent the structure and semantic content of source code 510, such as syntax trees, graphs, symbol tables or other suitable data structures. The intermediate representation may be configured to preserve information identifying the syntactic and semantic features of source code 510, and may also include additional annotation information generated through the parsing and analysis of source code 510. For example, the intermediate representation may include control flow graphs that explicitly identify the control relationships among different blocks or segments of source code 510. Such control flow information may be employed by back end 530 to determine, for example, how functional portions of source code 510 may be rearranged (e.g., by optimizer 540) to improve performance while preserving necessary execution-ordering relationships within source code 510.

Back end 530 may generally be configured to transform the intermediate representation into object code 560. Specifically, in the illustrated embodiment, optimizer 540 may be configured to transform the intermediate representation in an attempt to improve some aspect of the resulting object code 560. For example, optimizer 540 may be configured to analyze the intermediate representation to identify memory or data dependencies. In some embodiments, optimizer 540 may be configured to perform a variety of other types of code optimization such as loop optimization (e.g., loop fusion, loop unrolling, etc.), data flow optimization (e.g., common subexpression elimination, constant folding, etc.), or any other suitable optimization techniques.

To perform loop optimization, optimizer 540 may analyze the intermediate representation to determine if one or more program loops are included. If a program loop is identified, then optimizer 540 may determine a number of instructions to delay a beginning of execution of the program loop from the initialization of the program loop. Optimizer 540 may generate a delayed zero-overhead loop instruction depending upon the determined number of instructions and add the generated delayed zero-overhead loop instruction to the intermediate representation.

Code generator 550 may be configured to process the intermediate representation, as transformed by optimizer 540, in order to produce object code 560. For example, code generator 550 may be configured to generate machine instructions defined by the ISA of the target architecture such that execution of the generated instructions by a processor implementing the target architecture may implement the functional behavior specified by source code 510. In an embodiment, code generator 550 may also be configured to generate instructions corresponding to operations that may not have been inherent in source code 510, but which may have been added by optimizer 540 during the optimization process.

It is noted that, in other embodiments, compiler 500 may be partitioned into more, fewer or different components than those shown. For example, compiler 500 may include a linker (not shown) configured to take one or more object files or libraries as input and combine them to produce a single—usually executable—file. Alternatively, the linker may be an entity separate from compiler 500. As noted above, any of the components of compiler 500 may be implemented partially or entirely as software code stored within a suitable computer-accessible storage medium.

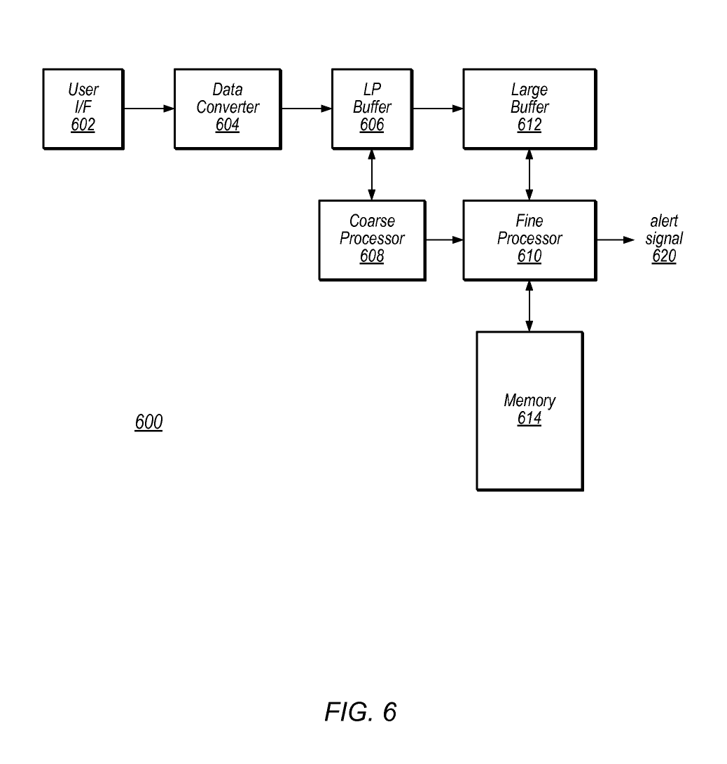

Turning to FIG. 6, a system utilizing an embodiment of a processor disclosed herein is illustrated. System 600 may monitor for user input and assert alert signal 620 upon detecting valid user input. In the illustrated embodiment, system 600 includes user interface 602, data converter 604, low power (LP) buffer 606, coarse processor 608, fine processor 610, large buffer 612, and memory 614.

User interface 602 represents any suitable input device allowing a user to interact with a computing system, such as, for example, a touch sensitive panel, a camera, or microphone. In the present embodiment, user interface 602 represents a digital audio microphone, such as may be used in a mobile phone or audio recorder. User interface 602 samples received sound waves and converts the sound waves into a digital signal, such as, e.g., a pulse density modulated (PDM) bitstream, dependent upon a decibel level of the sound wave. The PDM bitstream is sent to data converter 604.

Data converter 604 receives the PDM bitstream from user interface 602 and converts the PDM bitstream into a data format that can be processed by coarse processor 608 and fine processor 610. Data converter 604 converts the PDM data into pulse-code modulated (PCM) data. Data converter 604 stores the PCM data to LP buffer 606.

In the present embodiment, LP buffer 606 is a memory used to store a predetermined amount of PCM data. The amount of PCM data stored by LP buffer 606 corresponds to an audio signal of sufficient length of time for coarse processor 608 to process and detect a pattern. The size of LP buffer 606 is determined by balancing a need to store sufficient PCM data while maintaining sufficiently low enough power consumption to remain active during a reduced power mode of system 600.

Coarse processor 608 retrieves the PCM data from LP buffer 606 and processes the data to determine if a predetermined audio pattern has been received by user interface 602. The audio pattern may correspond to spoken keyword or keywords. Coarse processor 608 may not be capable of detecting the spoken keyword with high accuracy. For example, coarse processor 608 may simply be capable of detecting a spoken voice versus other ambient sounds. Coarse processor 608, however, operates with a suitably low enough power consumption such that it may remain active during a reduced power mode of system 600, including a reduced power mode in which fine processor 610, large buffer 612 and memory 614 may be in reduced power modes or even powered off modes.

Coarse processor 608 may correspond to an embodiment of processor 201 in FIG. 2. During processing of the PCM data, program instructions performed by coarse processor 608 may include one or more delayed zero-overhead instructions. Upon detecting PCM data that may correspond to the spoken keyword, coarse processor 608 may assert a signal to fine processor 610. Coarse processor 608 may also assert a signal to LP buffer 606 to cause LP buffer 606 to send the PCM data to large buffer 612.

Similar to LP buffer 606, large buffer 612 is a memory used to store PCM data. Large buffer 612 may be capable of storing a larger amount of PCM data than LP buffer 606. Large buffer 612 is capable of storing PCM data corresponding to an audio signal of sufficient length of time for fine processor 610 to process and detect a pattern within the PCM data. Since large buffer 612 may be placed into a reduced power mode while LP buffer 606 remains active, the size of large buffer 606 may not be limited by a need to maintain low power consumption.

Fine processor 610, upon detecting the signal asserted by coarse processor 608, analyses the PCM data in large buffer 612. In some embodiments, fine processor 610 may be in a reduced power or power off mode upon receiving the asserted signal. In response to receiving the asserted signal, fine processor 610 may cause large buffer 612 to receive additional PCM data from data converter 604, either directly or via LP buffer 606. Both the initial PCM data and additional PCM data in large buffer 612 is analyzed by fine processor 610 in order to determine if the keyword was spoken.

In some embodiments, fine processor 610 may correspond to an embodiment of processor 201 in FIG. 2. As described above for coarse processor 608, fine processor 610 may execute a series of program instructions that include one or more delayed zero-overhead instructions. The program instructions executed by fine processor 610 may cause fine processor 610 to compare the PCM data in large buffer 612 with data in memory 614 that corresponds to an audio pattern associated with the keyword. Upon determining that at least a portion of the PCM data in large buffer 612 sufficiently matches the audio pattern associated with the keyword, fine processor 608 asserts alert signal 620. Alert signal 620 may be used to notify a main application processor (not shown) that a user is initiating a command or requesting an action from system 600.

It is noted that system 600 of FIG. 6 is merely an example of system utilizing a processor disclosed herein. The functional units shown in FIG. 6 are limited for clarity. Other embodiments may include additional functional units. Arrangement of the illustrated functional units may be different in other embodiments. Although audio patterns are used in this example, any suitable type of input may be received and analyzed.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a first counter circuit; and
an execution unit configured to:
receive and execute a first program instruction of a plurality of program instructions, wherein the first program instruction includes a first number corresponding to a number of program instructions in a first subset of the plurality of program instructions, a second number corresponding to a number of times to execute a second subset of the plurality of program instructions, and a third number corresponding to a number of program instructions in the second subset;
initialize a first count value in the first counter circuit to the second number in response to the execution of the first program instruction;
execute the first subset of the plurality of program instructions; and
execute the second subset of the plurality of program instructions;
wherein the first counter circuit is configured to modify the first count value in response to a determination that a last program instruction of the second subset has been retired.

2. The apparatus of claim 1, wherein the execution unit is further configured to repeat execution of the second subset of the plurality of program instructions in response to a determination that the first count value is greater than a predetermined value.

3. The apparatus of claim 1, wherein the execution unit is further configured to execute a program instruction excluded from the first subset and the second subset of the plurality of program instructions in response to a determination that the first count value is equal to a predetermined value.

4. The apparatus of claim 1, further comprising a second counter circuit, wherein the execution unit is further configured to initialize a second count value in the second counter circuit to the first number in response to the execution of the first program instruction, and wherein the second counter circuit is configured to modify the second count value in response to a determination that a program instruction in the first subset has been executed.

5. The apparatus of claim 4, wherein the execution unit is further configured to execute a first program instruction of the second subset of the plurality of program instructions in response to a determination that the second count value equals a predetermined value.

6. The apparatus of claim 1, wherein the execution unit is further configured to:
add, in response to the execution of the first program instruction, the first number to a first value of a program counter to generate a fourth number; and
store the fourth number in a compare register.

7. The apparatus of claim 6, wherein the execution unit is further configured to execute a first program instruction of the second subset of the plurality of program instructions in response to a determination that a second value of the program counter equals the fourth value.

8. A method, comprising:
receiving and executing a first program instruction of a plurality of program instructions, wherein the first program instruction includes a first number corresponding to a number of program instructions in a first subset of the plurality of program instructions, a second number corresponding to a number of times for executing a second subset of the plurality of program instructions, and a third number corresponding to a number of program instructions in the second subset;
initializing a first count value in a first counter circuit to the second number in response to executing the first program instruction;
executing the first subset of the plurality of program instructions;
executing the second subset of the plurality of program instructions; and
modifying the first count value in response to determining that a last program instruction of the second subset has been executed.

9. The method of claim 8, further comprising repeating execution of the second subset of the plurality of program instructions in response to determining that the first count value is greater than a predetermined value.

10. The method of claim 8, further comprising executing a program instruction excluded from the first subset and the second subset of the plurality of program instructions in response to a determination that the first count value is equal to a predetermined value.

11. The method of claim 8, further comprising:
initializing a second count value in a second counter circuit to the first number in response to executing the first program instruction; and
modifying the second count value in response to a determination that a program instruction in the first subset has been executed.

12. The method of claim 11, further comprising executing a first program instruction of the second subset of the plurality of program instructions in response to determining that the second count value equals a predetermined value.

13. The method of claim 8, further comprising, in response to executing the first program instruction:
adding the first number to a first value of a program counter to generate a fourth number; and
storing the fourth number in a compare register.

14. The method of claim 13, further comprising executing a first program instruction of the second subset of the plurality of program instructions in response to determining that a second value of the program counter equals the fourth value.

15. A system, comprising:
a memory configured to store a plurality of instructions; and
a first processor configured to:
retrieving a first program instruction from the plurality of instructions;
executing the first program instruction, wherein the first program instruction includes a first number corresponding to a number of program instructions in a first subset of the plurality of program instructions, a second number corresponding to a number of times to execute a second subset of the plurality of program instructions, and a third number corresponding to a number of program instructions in the second subset;
initialize a first count value in a first counter circuit to the second number in response to the execution of the first program instruction;
execute the first subset of the plurality of program instructions;
execute the second subset of the plurality of program instructions; and
modify the first count value in response to a determination that a last program instruction of the second subset has been executed.

16. The system of claim 15, wherein the first processor is further configured to repeat execution of the second subset of the plurality of program instructions in response to a determination that the first count value is greater than a predetermined value.

17. The system of claim 15, wherein the first processor is further configured to:
initialize a second count value in a second counter circuit to the first number in response to the execution of the first program instruction; and
modify the second count value in response to a determination that a program instruction in the first subset has been executed.

18. The system of claim 17, wherein the first processor is further configured to execute a first program instruction of the second subset of the plurality of program instructions in response to a determination that the second count value equals a predetermined value.

19. The system of claim 15, further comprising a first buffer configured to store first data corresponding to first audio information from a microphone, wherein the first processor is further configured to analyze the first data using the plurality of instructions to determine if the first audio information corresponds to a spoken word.

20. The system of claim 19, further comprising:
a second buffer configured to receive the first data from the first buffer and store second data corresponding to second audio information from the microphone; and
a second processor;
wherein the first processor is further configured to assert a power mode signal in response to a determination that the first data corresponds to a spoken word;
wherein the second processor is configured to:
transition from a reduced power mode to an operational mode in response to the assertion of the power mode signal; and
analyze the first data and the second data to determine if at least a portion of the first audio information in combination with the second audio information corresponds to at least one predetermined keyword.
